(19) United States
(12) Patent Application Publication
(10) Pub. No.: US 2003/0237004 A1
(43) Pub. Date: Dec. 25, 2003

(54) Certificate validation method and apparatus thereof

(75) Inventor: Mine Okamura, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/465,320

(22) Filed: Jun. 18, 2003

(30) Foreign Application Priority Data
Jun. 25, 2002 (JP) P2002-185022

(51) Int. Cl. H04L 9/00

(52) U.S. Cl. 713/201; 713/175; 713/176

(57) ABSTRACT

Virtual Private Network (VPN) client 1 and M access gateways 3, 4 and 5 each possess a public key cryptography key pair (i.e., a private key and a public key). If VPN client 1 sends Public Key Infrastructure (PKI) compliant signature based authentication information to an access gateway 3, 4 or 5, the access gateway does not itself verify this authentication information. Instead, it entrusts this processing to an authentication server 8, 9 or 10 and receives the verification result, via authentication server proxy 7. Conversely, generation of PKI compliant signature based authentication information to be sent from an access gateway to a VPN client is carried out by the access gateway alone. The access gateway and the authentication server thus together implement PKI support but have the functions required for such support apportioned between them.

### BACKGROUND OF THE INVENTION

1. Field of the Invention

The present invention relates to a public key infrastructure (PKI) enabled certificate validation method and apparatus thereof, and to a PKI-enabled certificate validation program.

2. Description of Related Art

Hitherto, a PKI-enabled end entity has either been provided with all the validation functions required to support PKI, such as digital signature, certificate issue request, certificate content analysis and certificate validation; or none of these validation functions are provided and instead all of them, including management of the end entity's own private key and certificate, are entrusted to a proxy function part with an online connection to the end entity.

The enormous development costs involved in ensuring PKI support for an end entity provided with all the certificate validation functions, i.e., for a fully PKI-enabled end entity, has impeded the advancement of PKI support for end entities.

If a PKI specification has been fixed at the end entity side and a minimum degree of PKI support has been realized by complying with this specification, then when a communicating party with a PKI specification that differs from this established PKI specification appears, communication with that party is inevitably terminated and validation of the certificate refused.

This can be avoided by not fixing the PKI specification at the end entity side, but then customization has to be developed, with modification of the certificate content analysis function and the certificate validation policy in accordance with a plurality of PKI specifications of communicating parties whose certificates have to be validated. Suppose for example that M access gateways responsive to a virtual private network (VPN) client have a PKI-enabled certificate validation function. If a certificate with a different PKI specification appears and requires validation, the management level has to add, to all the M access gateways, a rule function for analyzing the specification of the newly appeared certificate.

However, problems have been encountered with schemes to make end entities such as access gateways PKI compliant by means of customized development and management methods of the sort described above. Not only are such schemes enormously expensive to develop, but they result in increased rather than decreased management costs. Hence they do not constitute practical solutions.

Alternative methods have been considered, including giving the certificate validation program an hierarchical structure so as to improve the productivity of program development and maintenance, and linking a plurality of existing certification authorities (CAs) in bridge fashion.

However, when a PKI is used for large number of purposes, as in the case of enterprise PKI, it is in practice technically difficult to give special treatment to a particular one of these purposes and to link the CAs of different enterprises. Hence these methods have not in fact been adopted as solutions to the above-mentioned problems.

On the other hand, in the case of an end entity that is not provided with a certificate validation function, i.e., an end entity that is not fully PKI enabled, a proxy function part connected online to this end entity manages the end entity's private keys and certificates online, and hence it is essential to find solutions to issues regarding the security of communications between the end entity and the proxy function part, and also regarding maintaining the security of the proxy function part itself. Hence once again this approach is enormously expensive.

### SUMMARY OF THE INVENTION

It is an object of the present invention to provide a PKI-enabled certificate validation method and apparatus thereof, and a PKI-enabled certificate validation program.

To achieve this object, the PKI-enabled certificate validation method of the invention comprises, in the context of a PKI-enabled certificate validation method which uses a PKI-enabled end entity to validate a certificate, extracting and separating at least user ID data, client certificate data, data for signing and a digital signature, and validating the client certificate on the basis of this extracted data.

This certificate validation preferably analyzes the content of the certificate on the basis of the above-mentioned extracted data, validates the certificate on the basis of the analyzed data, and responds to a validation request in accordance with the result of this validation. Preferably, parallel certificate validation processing is performed.

In the present invention, when information for PKI-compliant certificate validation using digital signatures is input, firstly at least user ID data, client certificate data, data for signing and digital signature are extracted and separated. After the required data has been extracted, the client certificate is validated on the basis of the extracted data. This certificate validation using a public key is carried out separately and independently from the processing whereby the private key of public key cryptography is used to generate, and send to the communicating party, a PKI-compliant validation result.

According to the present invention, by implementing overall PKI support while apportioning the necessary functions to achieve this, if a new type of certificate with a different PKI specification to be supported becomes a target for validation, this can be dealt with simply by adding a certificate validation step that uses the public key, and it is not necessary to modify the entire set of processing steps including those that use the private key. The present invention is therefore capable of providing flexible PKI support. This advantage is particularly remarkable when certificates are validated by the above-mentioned parallel processing.

A PKI-enabled certificate validation apparatus using the above-described PKI-enabled certificate validation method of the present invention is a PKI-enabled certificate validation apparatus which uses a PKI-enabled end entity to validate a certificate, wherein the PKI-enabled end entity function part is divided into a first function part and a second function part, whereof the first function part extracts and separates at least user ID data, client certificate data, data for signing and digital signature, and outputs this extracted data to the second function part, and the second function part validates the client certificate on the basis of the extracted data input from the first function part.

The second function part is preferably configured to implement the above-mentioned certificate validation by analyzing the content of the certificate on the basis of the above-mentioned extracted data, validating the certificate on the basis of the analyzed data, and responding to a validation request in accordance with the result of this validation. The second function part is preferably configured to perform parallel processing of certificate validation.

In the present invention, the first function part and a party wishing to communicate with the first function part both possess a public key cryptography key pair (i.e., a private key and a public key). If PKI-compliant signature based authentication information is sent from the above-mentioned party to the first function part, the first function part does not itself verify this authentication information but rather entrusts this processing to the second function part and just receives the verification result. Conversely, generation of PKI-compliant signature based authentication information to be sent from the first function part to the communicating party is carried out by the first function part alone.

The two entities, i.e., the first function part and the second function part, thus together implement PKI support but have the functions required for such support apportioned between them. This provides the following advantage. Namely, if the types of certificate that have to be supported increase, is not necessary to add new certificate validation functions to the first function part. In other words, the PKI support obtained is more flexible than if full PKI support were provided by the first function part alone.

Although the apparatus described above was described as if it was constructed from hardware, it may alternatively be constructed from software by dividing the PKI-enabled end entity function part into a first function part and a second function part according to function, wherein the first function part is constructed as software which implements the functions of using a public key to extract and separate at least user ID data, client certificate data, data for signing and digital signature, and outputting this extracted data to the second function part; and the second function part is constructed as software which implements the function of validating client certificates on the basis of the above-mentioned extracted data that is input from the first function part. These two pieces of software serve to make a computer perform the above-described functions.

The advantage of constructing the PKI-enabled end entity function part as software in the way outlined above, thereby obtaining a PKI-enabled certificate validation program, is that by installing this program on an existing computer and in particular on a personal computer, validation of certificates can be performed rapidly and securely.

The present invention is not restricted to the specific content described above and is capable of being modified in various ways within the spirit and scope of the basic underlying principles disclosed and claimed herein.

### BRIEF DESCRIPTION OF THE DRAWINGS

Specific embodiments of the present invention will now be described, by way of example only, with reference to the accompanying drawings in which:

FIG. 1 is a block diagram of a first mode of embodying the present invention;

FIG. 2 is a block diagram showing a specific configuration of an access gateway, the authentication server proxy and an authentication server in the first mode of embodying the invention, shown in FIG. 1;

FIG. 3 is a sequence chart of the overall operation of the first mode of embodying the invention, shown in FIG. 1 and FIG. 2;

FIG. 4 is a block diagram of a second mode of embodying the present invention;

FIG. 5 is a sequence chart of the overall -operation of the second mode of embodying the invention, shown in FIG. 4;

FIG. 6 is a block diagram of a third mode of embodying the present invention;

FIG. 7 is a block diagram showing a specific example of an access gateway, the authentication server proxy and an authentication server in the third mode of embodying the invention, shown in FIG. 6;

FIG. 8 is a sequence chart of the overall operation of the third mode of embodying the invention, shown in FIG. 6 and FIG. 7; and

FIG. 9 is a block diagram of a fourth mode of embodying the present invention.

### DETAILED DESCRIPTION OF THE PREFERRED EMBODIMENTS

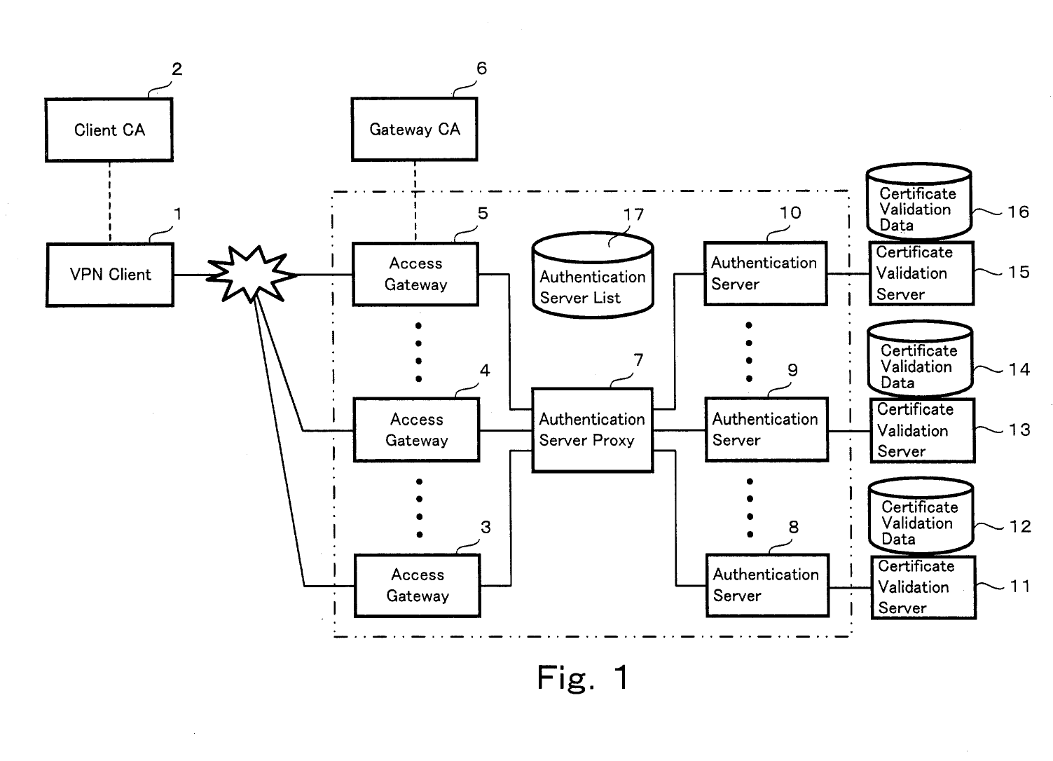

A feature of this invention relates to the authentication scheme that is used when PKI-enabled VPN client 1 (see FIG. 1) exchanges keys with access gateways 3, 4 and 5 on the basis of a protocol such as Internet Key Exchange (IKE) in order to construct a virtual private network. This authentication scheme utilizes the signing function of public key cryptography. Although other modes of embodying the invention, shown in other drawings, have partially modified configurations, this feature of the invention is shared by all embodiments of the invention.

As described above, the PKI-enabled certificate validation method of the invention comprises, in the context of a PKI-enabled certificate validation method which uses a PKI-enabled end entity to validate a certificate, extracting and separating at least user ID data, client certificate data, data for signing and a digital signature, and validating the client certificate on the basis of this extracted data. A mode of embodying a certificate validation apparatus used for the PKI-enabled certificate validation method of the present invention will now be described with reference to the drawings.

The basic configuration of a PKI-enabled certificate validation apparatus according to this invention is as follows. Namely, the PKI-enabled end entity function part is divided into a first function part and a second function part. The first function part extracts and separates at least user ID data, client certificate data, data for signing and digital signature, and outputs this extracted data to the second function part. The second function part validates the client certificate on the basis of the extracted data input from the first function part.

In the embodiment shown in FIG. 1, the first function part has, in correspondence with PKI-enabled VPN client 1, a plurality (M) of access gateways 3, 4 and 5, and gateway certification authority (CA) 6 for issuing a plurality (M) of certificates corresponding to the above-mentioned plurality of access gateways 3, 4 and 5. Given this configuration, the first function part implements the functions of extracting and separating at least user ID data, client certificate data, data for signing and digital signature, and outputting this extracted data. In FIG. 1, referencing numeral 2 denotes a client certification authority (CA) for issuing a certificate for VPN client 1.

The second function part validates a client certificate on the basis of the extracted data input from the first function part. More specifically, it implements the function of certificate validation by analyzing certificate content on the basis of the extracted data, validating the certificate on the basis of the analyzed data, and responding to a validation request in accordance with the result of this validation. The second function part has an authentication server proxy and an authentication part.

The authentication server proxy identifies the type of certificate contained in the extracted data, allocates certificate validation processing corresponding to the certificate type, and responds to a request for a validation result. In the embodiment shown in FIG. 1, the authentication server proxy is denoted by referencing numeral 7.

The above-mentioned authentication part validates certificates on the basis of the extracted data distributed by authentication server proxy 7 in accordance with certificate type, and outputs the validation result to authentication server proxy 7. More specifically, the authentication part has authentication servers and certificate validation servers. The authentication servers are adapted to analyze certificate content, output requests for certificate validation to the certificate validation servers, and respond to requests from the authentication server proxy for validation results. The certificate validation servers are adapted to validate certificates on the basis of the analyzed data from the authentication servers, in response to certificate validation requests from the authentication servers, and to output the results of this validation to the authentication servers. The embodiment shown in FIG. 1 has a plurality (N) of authentication servers 8, 9 and 10, and a plurality of certificate validation servers 11, 13 and 15 corresponding to these authentication servers. Given this configuration, the second function part is adapted to perform parallel certificate validation processing.

In FIG. 1, referring to the above-mentioned plurality of access gateways, a first access gateway terminating the VPN is referenced by numeral 3, a second access gateway terminating the VPN is referenced by numeral 4, and the M-th access gateway terminating the VPN is referenced by numeral 5. Next, referring to the above-mentioned plurality (N) of authentication servers, a first authentication server allocated by authentication server proxy 7 to correspond to first access gateway 3 is referenced by numeral 8, a second authentication server allocated by authentication server proxy 7 to correspond to second access gateway 4 is referenced by numeral 9, and the N-th authentication server allocated by authentication server proxy 7 to correspond to M-th access gateway 5 is referenced by numeral 10. In addition, the certificate validation server corresponding to first authentication server 8 is referenced by numeral 11, the certificate validation server corresponding to second authentication server 9 is referenced by numeral 13, and the certificate validation server corresponding to N-th authentication server 10 is referenced by numeral 15.

In FIG. 1, certificate validation servers 11, 13 and 15 hold certificate validation data 12, 14 and 16 respectively. However, these certificate validation data 12, 14 and 16 may alternatively be held by authentication servers 8, 9 and 10 respectively. In other words, authentication servers 8, 9 and 10 may be additionally provided with the functions of certificate validation servers 11, 13 and 15. A configuration where authentication servers 8, 9 and 10 hold certificate validation data 12, 14 and 16 has the advantage that certificate validation servers 11, 13 and 15 respectively corresponding to these data are not required, thereby simplifying to this extent the overall configuration.

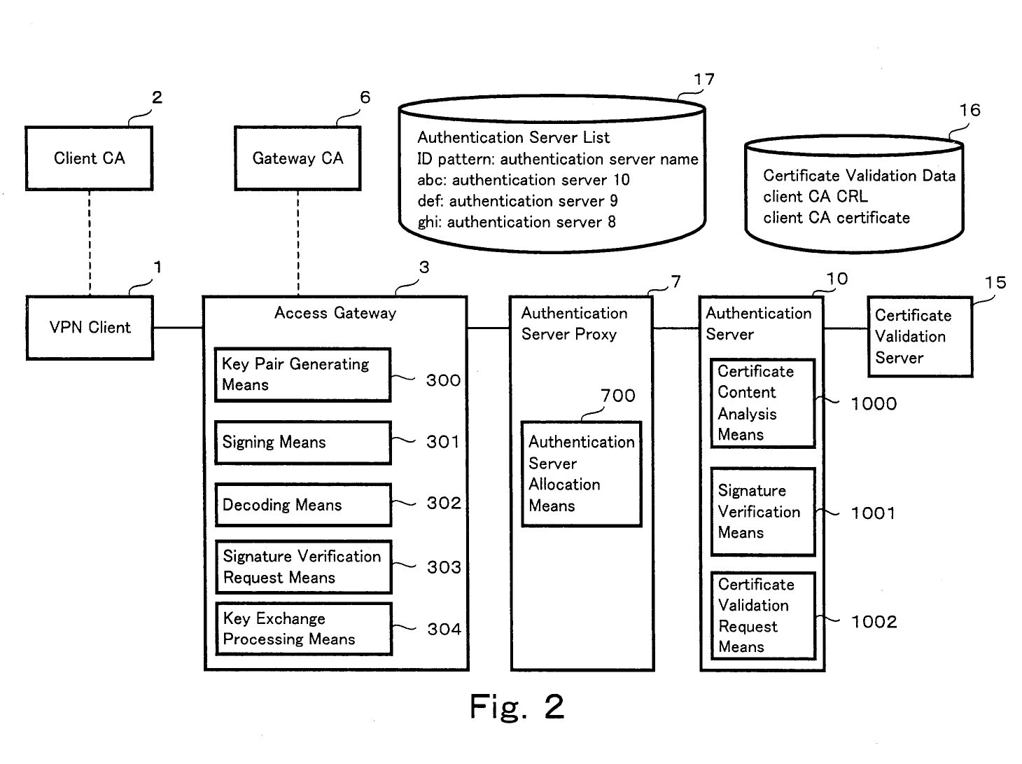

The configuration of the access gateways (3, 4 and 5), the authentication server proxy (7) and the authentication servers (8, 9 and 10) shown in FIG. 1 will now be described in greater detail with reference to FIG. 2, which illustrates the configuration of access gateway 3, the configuration of corresponding authentication server 10, and the configuration of authentication server proxy 7.

In FIG. 2, communication between access gateway 3 and authentication server 10 is performed using an existing transport protocol for authentication information such as Remote Authentication Dial-In User Service (RADIUS) or DIAMETER.

Access gateway 3 has key pair generating means (key pair generating function) 300, signing means (signing function) 301, decoding means (decoding function) 302, signature verification request means (signature verification request function) 303 and key exchange processing means (key exchange processing function) 304.

Key pair generating means 300 performs processing to generate a key pair comprising a private key and a public key of public key cryptography. This function is optional. Signing means 301 performs processing to generate a signature for input data, using the private key of the key pair generated by key pair generating means 300.

Decoding means 302 performs processing to decode the input data, using the private key of the key pair generated by key pair generating means 300. Signature verification request means 303 performs processing to request signature verification by sending the digital signature received from VPN client 1 to authentication server proxy 7 along with the user ID and certificate of VPN client 1; and to receive the results of the signature verification from authentication server proxy 7.

Key exchange processing means 304 performs processing to exchange keys with VPN client 1, using a key exchange protocol such as Internet Key Exchange (IKE).

The other access gateways 4 and 5 are similar to access gateway 3 in that they have key pair generating means (300), signing means (301), decoding means (302), signature verification request means (303) and key exchange processing means (304), but they differ from access gateway 3 in respect of the private key and the public key generated by the key pair generating means, and in respect of the type of certificate generated by gateway CA 6.

Authentication server proxy 7 has authentication server allocation means 700. Authentication server allocation means 700 performs the following processing. Namely, it determines a suitable authentication server (8, 9 or 10) on the basis of data, such as the user ID of VPN client 1, received from an access gateway (3, 4 or 5); sends the digital signature and the user ID and certificate of VPN client 1 to the selected authentication server, and requests the authentication server to verify the signature; receives a validation result from the authentication server; and sends this to the access gateway.

Authentication server 10 has certificate content analysis means (certificate content analysis function) 1000, signature verification means (signature verification function) 1001 and certificate validation request means (certificate validation request function) 1002.

Certificate content analysis means 1000 performs processing to analyze the certificate received from authentication server proxy 7 and to extract the user ID of VPN client 1. Signature verification means 1001 uses the certificate of VPN client 1, which it has likewise received, to verify the digital signature received from authentication server proxy 7, and to send the verification result to authentication server proxy 7. Certificate validation request means 1002 performs processing to send, to certificate validation server 15, the certificate of VPN client 1 received from authentication server proxy 7; to receive the validation result from certificate validation server 15; and to send this result to authentication server proxy 7.

Certificate validation data 16 held by authentication server 10 contains the certificate revocation list (CRL) of client CA 2 and the certificate of client CA 2 itself, these being issued by client CA 2. Certificate validation data 12 and 14 each likewise includes the CRL of a client CA and the certificate of a client CA other than client CA 2, these being issued by client CAs other than client CA 2. It may be noted that the above-mentioned certificate revocation list is data which lists, for those VPN client certificates issued by client CA 2 whose validity has been revoked, the certificate serial number and the time and date of the revocation, and that this data too is signed using the private key of client CA 2.

Referring to FIG. 1, VPN client 1 supports an existing PKI. VPN client 1 is issued in advance, on the basis of an existing method, with a certificate from client CA 2, and holds this certificate. Access gateways 3, 4 and 5 are respectively issued in advance, either directly or indirectly, and on the basis of an existing method, with certificates from gateway CA 6, and hold these certificates. It may be noted that access gateway 3 for example extracts the public key generated within the access gateway by key pair generation means 300 and may then be issued with its certificate either after passing the extracted public key through the network to gateway CA 6, or after use of some non-network method. Alternatively, an entity such as gateway CA 6 may generate respective key pairs for access gateways 3, 4 and 5. These key pairs are handed over to the access gateways by some means, whereupon access gateways 3, 4 and 5 use their respective keys to receive their certificates from gateway CA 6.

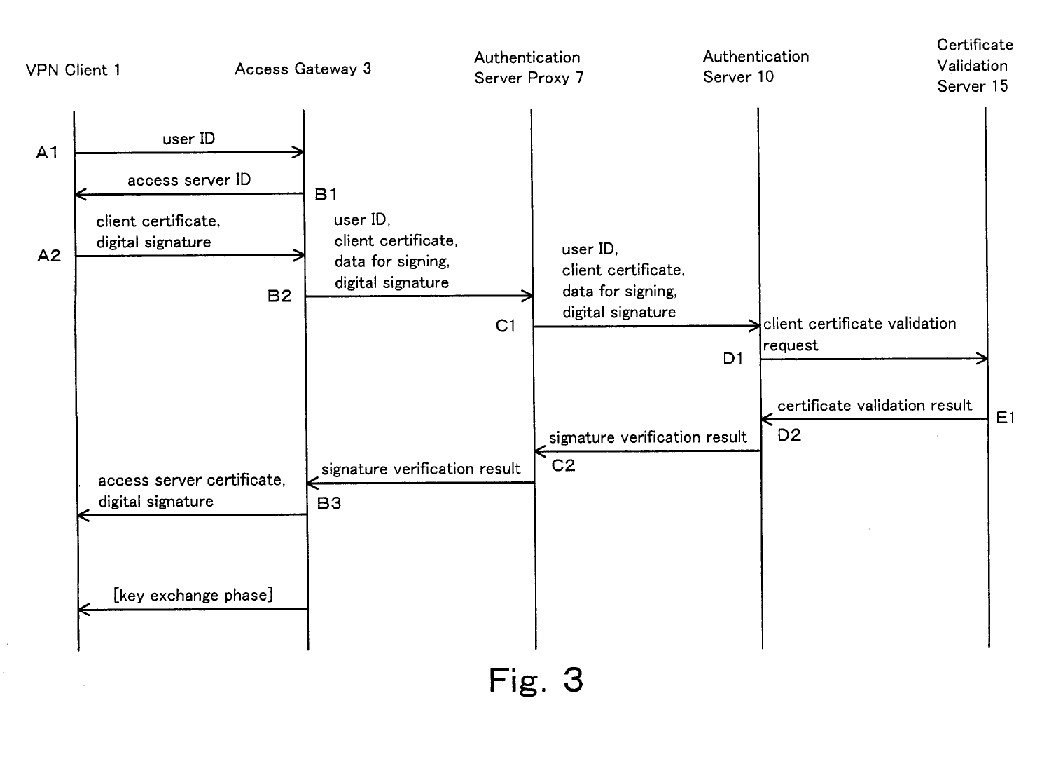

Next, a more detailed description of the overall operation of this invention will be given with reference to the sequence chart of FIG. 3. Firstly, VPN client 1 sends a user ID to access gateway 3 (Step A1), and access gateway 3 sends its user ID (i.e., the access server ID) to VPN client 1 (Step B1).

Next, VPN client 1 creates a digital signature by using the PKI signing function to sign some data for signing, this data consisting of a random number obtained by exchange with access gateway 3, and sends this digital signature to access gateway 3 along with VPN client 1's certificate (Step A2).

Access gateway 3 uses signature verification request means 303 to output, to authentication server proxy 7, the user ID, the certificate of VPN client 1 and the digital signature, all of which have been received from VPN client 1, together with the data for signing, which access gateway 3 itself holds (Step B2).

Authentication server proxy 7 obtains the user ID pattern of VPN client 1 on the basis of the user ID of VPN client 1, the certificate of VPN client 1, the data for signing and the digital signature, all of which have been received from access gateway 3, and employs authentication server allocation device 700 which uses authentication server list 17 to determine and allocate an appropriate authentication server to which to hand over the data from access gateway 3. In the present example it is assumed that authentication server 10 has been selected in this way.

Assuming that authentication server allocation device 700 has selected authentication server 10, authentication server proxy 7 sends to this authentication server 10 the user ID of VPN client 1, the certificate of VPN client 1, the digital signature and the data for signing, all of which have been received from access gateway 3 (Step C1).

When selected authentication server 10 receives this data from authentication server proxy 7, it uses certificate content analysis means 1000 to confirm that the digital signature and the data for signing are correct. Then, utilizing the certificate of VPN client 1, it verifies the digital signature by means of signature verification means 1001.

Next, authentication server 10 uses certificate content analysis means 1000 to analyze the content of the certificate of VPN client 1, and verifies whether the user ID is contained in this certificate. It is not necessary for the received user ID to completely match the user ID contained in the certificate, and authentication server 10 performs the above-mentioned verification in accordance with verification rules that are determined on a system-by-system basis.

Next, authentication server 10 uses certificate validation request means 1002 to send a request for validation of VPN client 1's certificate to corresponding certificate validation server 15 (Step D1).

When certificate validation server 15 receives the certificate validation request from authentication server 10, it uses certificate validation data 16 to validate the certificate of VPN client 1, and sends back the validation result for that certificate to authentication server 10 (Step E1). If the configuration employed is such that it is authentication server 10 rather than certificate validation server 15 which holds the certificate validation data (16), i.e., if certificate validation server 15 is not required, then authentication server 10 validates the certificate of VPN client 1 directly.

Authentication server 10 sends back the result of the signature verification, this having been obtained by signature verification means 1001, to authentication server proxy 7 (Step D2).

When authentication server proxy 7 receives the signature verification result from authentication server 10, it sends this result to access gateway 3 (Step C2). If the signature verification result received from authentication server proxy 7 is positive, access gateway 3 uses signing means 301 to sign some data for signing, this data consisting of a random number obtained by exchange with VPN client 1, and sends it to VPN client 1 along with the certificate which gateway CA 6 has issued to access gateway 3 (Step B3).

VPN client 1 authenticates access gateway 3 by utilizing the usual PKI-compliant functions on the certificate and signature received from access gateway 3 to validate the signature and certificate, and to verify the user ID of access gateway 3.

When processing using public keys in the manner described above has been carried out and mutual authentication has been completed, the processing between VPN client 1 and access gateway 3 shifts to the key exchange phase so that these two entities can perform processing using a shared key that is distinct from the keys of the above-mentioned key pair. This shared key is shared between VPN client 1 and access gateway 3 using key exchange processing means 304.

In this mode of embodying the invention, if a client CA certificate that is outside the scope of validation by authentication servers 8, 9 and 10 and certificate validation servers 11, 13 and 15 appears and requires validation, an access gateway for performing mutual authentication with the newly appeared client is added, together with an authentication server, a certificate validation server and the certificate validation data required to perform this authentication. Note, however, that because new PKI specifications can be supported by existing access gateways, it is not essential to add a new access gateway.

If an access gateway is added, it does not have to incorporate client certificate data, and essentially a general-purpose access gateway is sufficient. Note, however, that because the access gateway requests public key based validation by the authentication server, the certificate validation server and the certificate validation data that are added at the same time as the access gateway, it is necessary to have installed software for extracting and separating the information needed for this request, specifically the user ID, the client name, the data for signing and a digital signature.

A more detailed description will now be given by way of a specific example. If, as in FIG. 1, there is an access from VPN client 1 to access gateway 3, first of all the user ID and the access server ID are exchanged between VPN client 1 and access gateway 3. It will be assumed that of these exchanged IDs, the user ID is “taro@abc.com”.

In order for access gateway 3 to authenticate VPN client 1, a PKI-compliant digital signature and client certificate are sent from VPN client 1 to access gateway 3.

Access gateway 3 does not itself verify the digital signature sent from-VPN client 1, but rather uses signature verification request means 303 to make a signature verification request to authentication server proxy 7. In other words, as shown in Step B2 of FIG. 3, access gateway 3 sends to authentication server proxy 7, via signature verification request means 303, the user ID “taro@abc.com”, the certificate of VPN client 1, some data for signing and the digital signature, all of which have been received from VPN client 1.

Authentication server proxy 7 uses authentication server allocation means 700 to extract the pattern “abc” (i.e., the host name) from the user ID “taro@abc.com” which has been received from access gateway 3; looks up authentication server list 17 and on the basis of the extracted pattern (“abc”) selects authentication server 10. In the embodiment shown in FIG. 2, authentication server list 17 has been set up so that if the pattern is “abc”, authentication server 10 is selected; if the pattern is “def” authentication server 9 is selected, and if the pattern is “ghi” authentication server 8 is selected. However, the embodiment is not restricted to these particular correspondences.

When authentication server 10 has been selected, authentication server proxy 7 sends to this authentication server 10 all the information that has been received from access gateway 3—i.e., the user ID “taro@abc.com”, the client certificate, the data for signing and the digital signature.

When authentication server 10 receives the data from authentication server proxy 7, it uses certificate content analysis means 1000 to analyze the content of the client certificate, and depending on the result of this analysis confirms whether or not the user ID “taro@abc.com” is contained in a set place in the client certificate (in other words, the user ID is listed at that place), thereby verifying the signature.

In order to validate the certificate of VPN client 1, authentication server 10 also uses certificate validation request means 1002 to send a request for validation of VPN client 1's certificate to certificate validation server 15.

When certificate validation server 15 receives the certificate validation request from authentication server 10, it uses certificate validation data 16 to validate the certificate of VPN client 1, and sends back the result of the validation to authentication server 10. If the verification result obtained by signature verification means 1001 is “OK”, authentication server 10 sends back this result to access gateway 3, via authentication server proxy 7.

At the stage when authentication of VPN client 1 at access gateway 3 side has been completed, authentication of access gateway 3 at the VPN client side is performed. Namely, in order for VPN client 1 to authenticate access gateway 3, access gateway 3 creates data for signing, uses signing means 301 to sign this data, and sends the data to VPN client 1 along with the certificate of access gateway 3.

When VPN client 1 receives these data from access gateway 3, it utilizes the conventional PKI-compliant functions to authenticate access gateway 3 by verifying the signature, validating the certificate and confirming the user ID of access gateway 3.

When mutual authentication is thus completed, the processing shifts to the key exchange phase and exchange of keys takes place between VPN client 1 and access gateway 3 via key exchange means 304, whereby these two entities alone share a secret key.

After this, IP Security Protocol-Virtual Private Network (IPsec-VPN) communication is set up between VPN client 1 and access gateway 3, using the shared secret key.

As noted above, if a client CA issued certificate that is outside the scope of validation by authentication servers 8, 9 and 10 and certificate validation servers 11, 13 and 15 appears and requires validation, an access gateway for performing mutual authentication with the newly appeared client is added, together with an authentication server, a certificate validation server and the certificate validation data required to authenticate this client. Note, however, that because new PKI specifications can be supported by existing access gateways, it is not essential to add a new access gateway.

If an access gateway is added, it does not have to incorporate client certificate data, and essentially a general-purpose access gateway is sufficient. Note, however, that because the access gateway requests public key based validation by the authentication server, the certificate validation server and the certificate validation data that are added at the same time as the access gateway, it is necessary to have installed software for extracting and separating the information needed for this request, specifically the user ID, the client name, the data for signing and a digital signature.

In FIG. 1 and FIG. 2, the VPN client, access gateways, authentication server proxy, authentication servers and certificate validation servers were each described as if they were hardware, but the invention is not restricted to this, and by constituting these parts as software, the invention may be configured as a certificate validation program for running the processing sequence shown in FIG. 3.

A first advantage of this first embodiment of the invention described above is that it ceases to be necessary to store a plurality of client CA certificates at each access gateway; and if a newly added client CA issued certificate appears and requires validation, it ceases to be necessary to add, to the access gateway, a function for validating the newly added certificate.

The reason for this is that the access gateways and the authentication servers are separate so that the response to the addition of a new client CA is simply to add a new authentication server to correspond to the added client CA, and to add, to the authentication server list held by the authentication server proxy, a pattern serving to identify the newly added authentication server (which includes the certificate validation server).

A second advantage is that the access gateways do not have to be dependent on the specification of the corresponding client CA, which means that general-purpose access gateways can be used.

The reason for this is that all the processing for which public keys are used—such as confirmation of user ID, signature verification and certificate validation—and which is dependent on the specification of the client CA, is entrusted to the authentication servers; while the access gateways only perform processing that is independent of the specification of the client CA, this being achieved simply by adding, to the access gateways, a validation pattern (e.g., adding a rule or the like which says which specific attribute the user ID in the certificate is included in, and—if an identifier has to be passed on to another process after validation has been completed—how that identifier corresponds with the user ID in the certificate). The method of adding such a validation pattern gives far lower development costs than when all the processing required for certificate validation is implemented as software and software is created for each access gateway.

A third advantage is that access gateways are able to maintain the same level of private key management security as when they have been made fully PKI-compliant.

The reason for this is that when an access gateway is authenticated by a client on the basis of PKI, because the access gateway has the capability of creating and signing a key pair, it can keep the private key management enclosed within the access gateway. In other words, the private key is not requested by the authentication server side, and the private key is not output from the access gateway, which is therefore capable of secure key management.

A fourth advantage is that, from the point of view of clients supporting different PKIs, whichever access gateway is accessed, each access gateway can support all these different PKIs.

The reason for this is that the access gateways and the authentication servers are separated, and the access gateways can distribute accesses, via the authentication server proxy, to a plurality of authentication servers which correspond to the different client CAs (i.e., because the access gateways entrust all the processing for which public keys are used—such as confirmation of user ID, signature verification and certificate validation—and which is dependent on the specification of the client CA, to the authentication servers).

A fifth advantage is that VPN clients support only an existing PKI and do not have to support new PKIs, which means that they are able to utilize an existing VPN.

The reason for this is that VPN clients are configured so that if there is a client CA to which they already conform, they can absorb its PKI specification at the authentication server side (i.e., while the access gateway remains unchanged, the authentication server absorbs the PKI specification).

Next, a detailed description will be given, with reference to accompanying drawings, of a second mode of embodying the present invention.

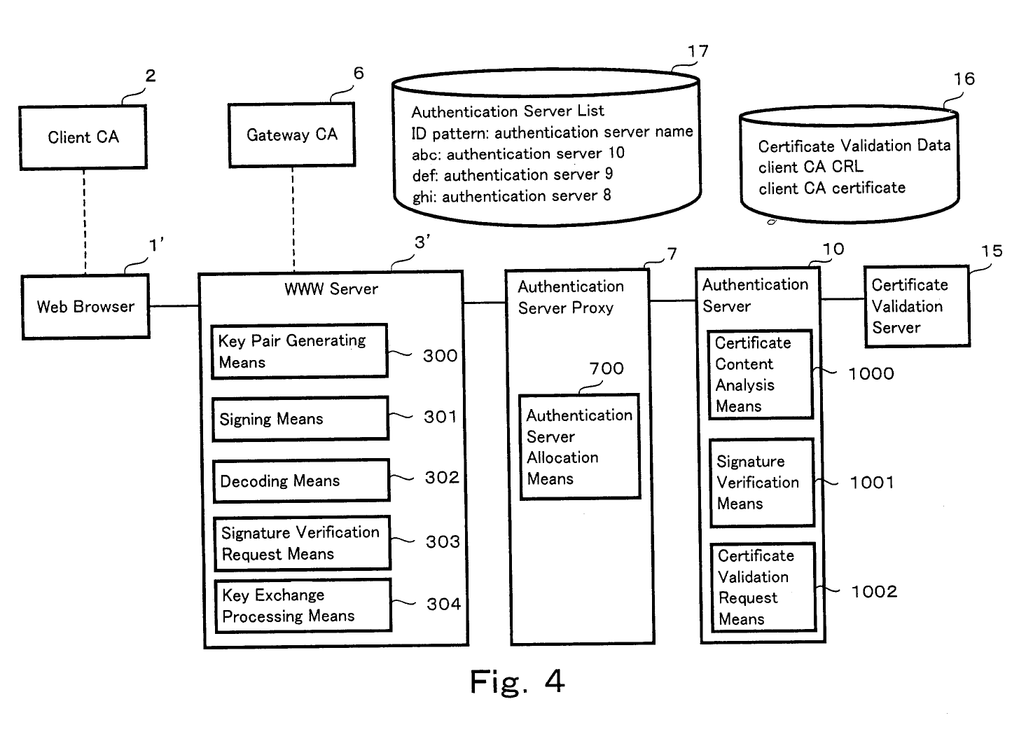

Referring to FIG. 4, in this second embodiment, VPN client 1 of FIG. 1 is replaced with Web browser 1′; access gateway 3 of FIG. 1 is replaced with WWW server 3′; and the sequence differs in that whereas the protocol between VPN client 1 and access gateway 3 in FIG. 1 was Internet Key Exchange (IKE), in FIG. 4 the protocol is Transport Layer Security (TLS). The specific configuration of WWW server 3′ and authentication server 10 in FIG. 4 is the same as in the first embodiment depicted in FIG. 1 and FIG. 2. Although FIG. 4 illustrates only one WWW server and one authentication server, there are in fact a plurality of WWW servers and authentication servers, as shown in FIG. 1.

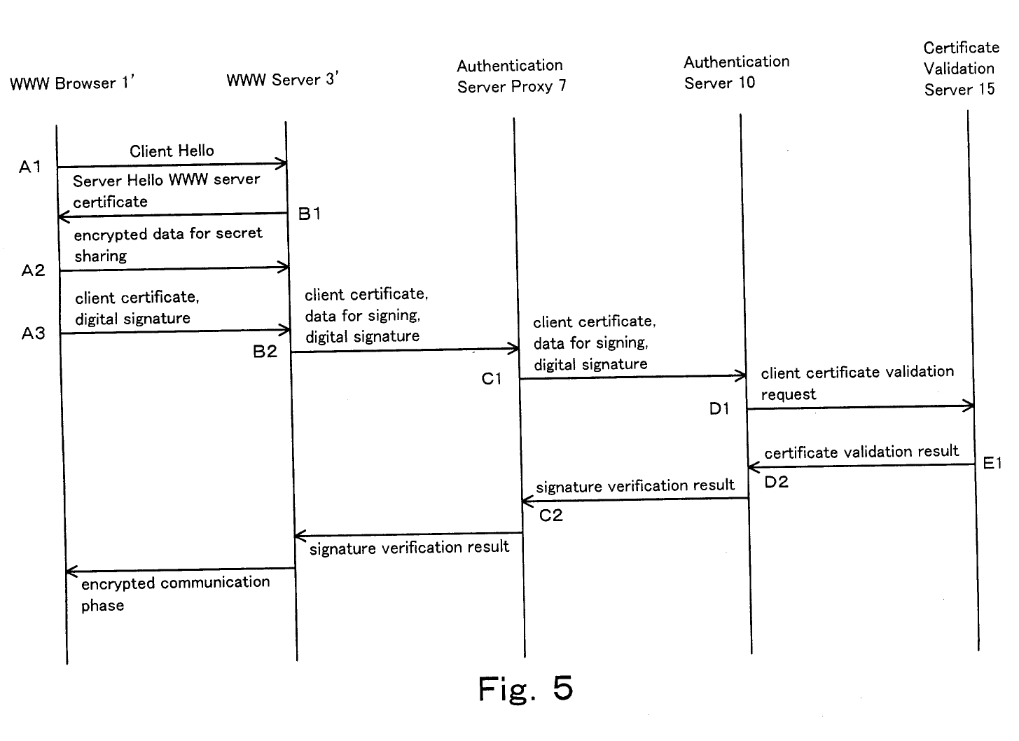

The operation of this second embodiment of the invention will be described in detail with reference to the sequence chart of FIG. 5. Firstly, Web browser 1′ sends a Client Hello (a communication commencement signal) as the initial step of the TLS protocol (Step A1).

WWW server 3′ sends to Web browser 1′ a Server Hello (a communication commencement signal) together with the WWW server certificate issued by server CA 6 (Step B1). The public key of the WWW server is contained in the WWW server certificate, but the private key is not contained. Next, Web browser 1′ uses the WWW server certificate sent from WWW server 3′ to create encrypted information for generating a shared secret, which can be decoded only by WWW server 3′, and sends this encrypted information to WWW server 3′ (Step A2).

Web browser 1′ uses the PKI signing function to sign some data consisting of a random number obtained by exchange with WWW server 3′, and sends this as a digital signature to WWW server 3′, along with the client certificate (i.e., the certificate which client CA 2 issues to Web browser 1′) (Step A3).

WWW server 3′ uses decoding means 302 and the private key of the key pair generated by key pair generating means 300 to decode the encrypted information for secret sharing that was received from Web browser 1′.

WWW server 3′ then sends, to authentication server proxy 7 via signature verification request means 303, the client certificate and digital signature received from Web browser 1′, along with some data for signing which is held by WWW server 3′ (Step B2).

On the basis of the client certificate of Web browser 1′ sent from WWW server 3′, authentication server proxy 7 obtains the user ID pattern of Web browser 1′, looks up authentication server list 17 and determines an appropriate authentication server. In the present example it is assumed that authentication server 10 has been selected in this way.

Authentication server proxy 7 sends to authentication server 10, by way of authentication server allocation means 700, the client certificate, the digital signature and the data for signing, which have been received from WWW server 3′ (Step C1).

When authentication server 10 receives the data from authentication server proxy 7, it uses certificate content analysis means 1000 to confirm that the digital signature and the data for signing are correct. Then, utilizing the above-mentioned client certificate, it verifies the digital signature by means of signature verification means 1001. Next, it sends a client certificate validation request to certificate validation server 15 via certificate validation request means 1002 (Step D1).

In response to the request from certificate validation request means 1002, certificate validation server 15 uses certificate validation data 16 to validate the client certificate and sends back the result of this validation to authentication server 10 (Step E1). The client certificate may be validated directly if authentication server 10 holds certificate validation data 16.

Authentication server 10 sends the signature verification result to authentication server proxy 7 (Step D2). When authentication server proxy 7 receives the signature verification result from authentication server 10, it sends it to WWW server 3′.

When authentication of Web browser 1′ is completed, processing shifts to the TLS-based encrypted communication phase, which uses a private key shared between Web browser 1′ and WWW server 3′, the latter having obtained this private key by decoding.

Mutual authentication is completed by successful encrypted communication in this manner.

In this mode of embodying the invention, if a client CA certificate (i.e., a certificate issued by client CA 2 to WWW browser 1′) that is outside the scope of validation by authentication server 10 and certificate validation server 15 appears and requires validation, a WWW server for performing mutual authentication with Web browser 1′ having the newly appeared certificate is added, together with an authentication server and a certificate validation server which are required to perform this authentication. Note, however, that because new PKI specifications can be supported by existing WWW servers, it is not essential to add a new WWW server.

If a WWW server is added, it does not have to incorporate client certificate data, and essentially a general-purpose WWW server is sufficient. Note, however, that because the WWW server requests public key based validation by the authentication server and the certificate validation server that are added at the same time as the WWW server, it is necessary to have installed software for extracting and separating the information needed for this request, specifically the user ID, the client name, the data for signing and a digital signature.

Next, this embodiment will be described by way of a specific example. If, as in FIG. 4, there is an access from Web browser 1′ to WWW server 3′ by Hypertext Transfer Protocol over Transport Layer Security (HTTP over TLS), the certificate of Web server 3′ issued by client CA 6 is sent from WWW server 3′ to Web browser 1′, and in this case the sent certificate contains the public key of the key pair generated by key pair generating means 300.

Web browser 1′ sends encrypted information obtained by using the public key from the WWW server certificate to encrypt data for secret sharing in order to authenticate WWW server 3′. In addition, in order for WWW server 3′ to authenticate Web browser 1′, WWW browser 1′ creates a digital signature and sends it along with the certificate which it has been issued with by client CA 2.

When WWW server 3′ receives this data from Web browser 1′, it uses decoding means 302 and the private key of the key pair issued by key pair generating means 300 to decode, by itself, the encrypted data for secret sharing, thereby obtaining the secret information. WWW server 3′ then sends, to authentication server proxy 7, the above-mentioned certificate, the data for signing and the digital signature, together with the public key information.

Authentication server proxy 7 extracts, from the certificate sent from WWW server 3′, the host name (“abc”) in the user ID of WWW browser 1′, looks up authentication server list 17 on the basis of this data and selects an authentication server. In the present example it is assumed that authentication server 10 has been selected in this way.

Authentication server proxy 7 sends the client certificate, the data for signing and the digital signature to the selected authentication server 10.

Authentication server 10 uses certificate content analysis means 1000 to analyze the data sent from authentication server proxy 7, confirms the user ID of WWW browser 1′ from the client certificate, verifies the digital signature using signature verification means 1001, and sends a client certificate validation request to certificate validation server 15.

Certificate validation server 15 uses certificate validation data 16 to validate the certificate and sends back the result of this validation to authentication server 10. Authentication server 10 then sends back the signature verification result to WWW server 3′ via authentication server proxy 7, whereupon authentication of Web browser 1′ by WWW server 3′ is completed.

Next, using the secret information which WWW server 3′ obtained from WWW browser 1′, the processing enters the encrypted communication phase. When this encrypted communication is successful, Web browser 1′ is able to authenticate WWW server 3′ and mutual authentication is completed.

If, as described above, a new certificate appears and requires validation by an authentication server, a WWW server for performing mutual authentication with Web browser 1′ having the newly appeared certificate is added, together with an authentication server and the certificate validation data which are required for authenticating Web browser 1′. Note, however, that because new PKI specifications can be supported by existing WWW servers, it is not essential to add a new WWW server.

If a WWW server is added, it does not have to incorporate certificate data, and essentially a general-purpose WWW server is sufficient. Note, however, that because the WWW server requests public key based validation by the authentication server and the certificate validation data that are added at the same time as the WWW server, it is necessary to have installed software for extracting and separating the information needed for this request, specifically the user ID, the client name, the data for signing and a digital signature.

Moreover, although the Web browser, WWW server, authentication server proxy and authentication server shown in FIG. 4 have been described as if they were hardware, the invention is not restricted to this, and by constituting these parts as software, the invention may be configured as a centralized processing program for certificate validation which runs the sequence shown in FIG. 5.

Advantages of the embodiment depicted in FIG. 4 and FIG. 5 are that because Web browsers and WWW servers are used instead of VPN clients and access gateways, it is not necessary to construct a VPN, communication using the existing Internet is possible, and a new network does not have to be provided.

Yet another mode of embodying the present invention will now be described in detail with reference to accompanying drawings. This third embodiment provides an authentication method that utilizes the public key encryption function of a key exchange protocol such as Internet Key Exchange (IKE).

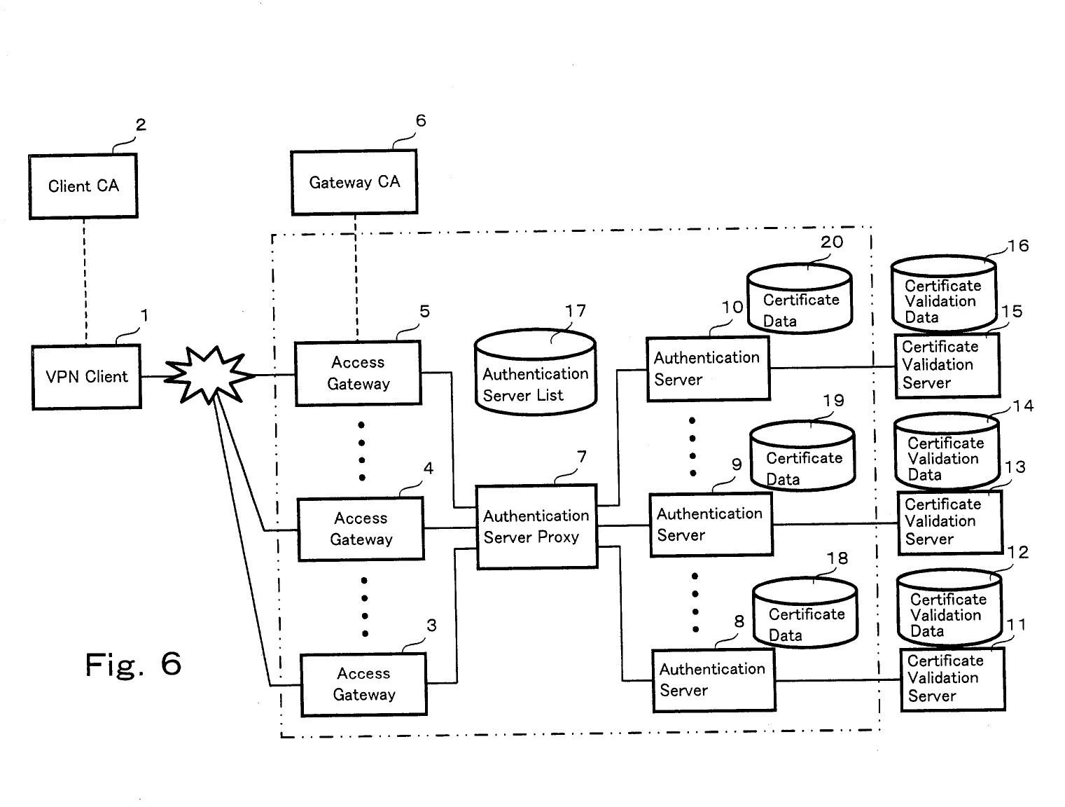

Referring to FIG. 6, this third embodiment of the invention differs from the first embodiment in that certificate data 18, 19 and 20 have been added to the configuration shown in FIG. 1. These certificate data 18, 19 and 20 are held by authentication servers 8, 9 and 10 respectively.

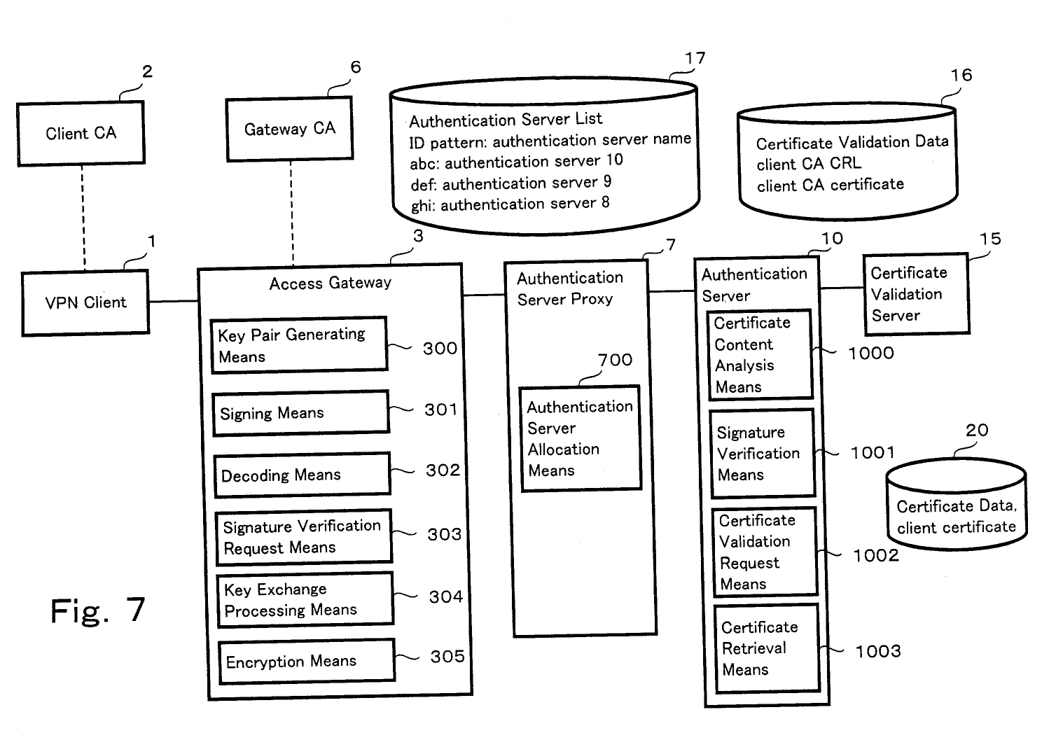

FIG. 7 shows a specific example of an access gateway, the authentication server proxy and an authentication server in the embodiment shown in FIG. 6. Referring to FIG. 7, this configuration differs from that of the first embodiment, shown in FIG. 2, in that encryption means 305 has been added to access gateway 3, and certificate retrieval means 1003 has been added to authentication server 10. Client certificates from client CA 2 and from other client CAs are contained in each of certificate data 18, 19 and 20.

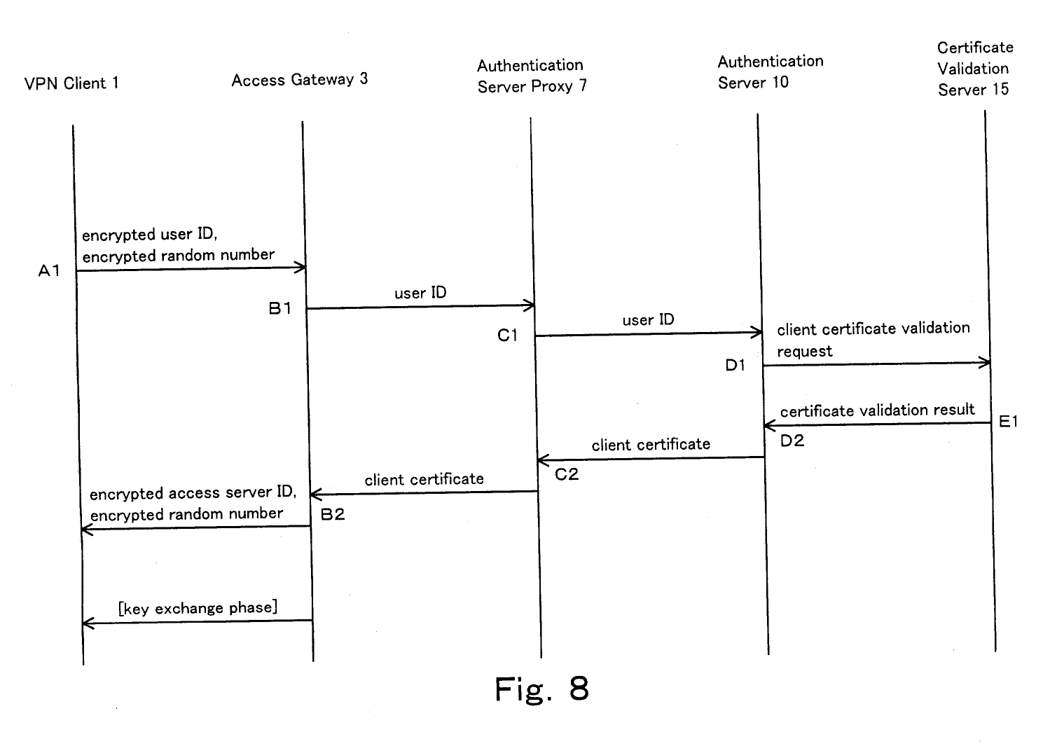

The operation of this third embodiment of the invention will be described in detail with reference to the sequence chart of FIG. 8. Firstly, VPN client 1 sends, to access gateway 3, the encrypted user ID of VPN client 1, this having been generated by using the public key of access gateway 3 to encrypt the client 1 user ID. VPN client 1 also sends encrypted random number data which is generated by using the public key of access gateway 3 to encrypt random number data (Step A1).

Access gateway 3 uses decoding means 302 to decode the encrypted information sent from VPN client 1, thereby obtaining the user ID and the random number.

Next, access gateway 3 sends the client user ID to authentication server proxy 7 (Step B1).

Authentication server proxy 7 obtains the ID pattern from this user ID, looks up authentication server list 17 and determines the authentication server which holds the certificate corresponding to that user ID. In the present example it is assumed that authentication server 10 has been selected in this way.

Authentication server proxy 7 sends the user ID of VPN client 1 to authentication server 10 (Step C1). Authentication server 10 uses certificate retrieval means 1003 to extract, from certificate data 20, the client certificate corresponding to the above-mentioned user ID.

Authentication server 10 then uses certificate validation request means 1002 to send, to certificate validation server 15, a client certificate validation request (Step D1).

Certificate validation server 15 uses certificate validation data such as the client CA certificate and the client CA certificate revocation list to validate the certificate, and sends back the result of this certificate validation to authentication server 10 (Step E1). Authentication server 10 sends back the client certificate to access gateway 3 via authentication server proxy 7 (Steps D2 and C2).

The client certificate that is sent back to access gateway 3 from authentication server proxy 7 contains the public key of the client.

Processing continues with access gateway 3 using the client's public key, which is contained in the client certificate that has been sent back from authentication server proxy 7, to encrypt the access gateway ID and a random number, which are sent to VPN client 1 (Step B2).

VPN client 1 uses its decoding means to decode the encrypted information that has been sent from access gateway 3, thereby obtaining the access gateway ID and the random number.

If mutual authentication is successfully achieved in this manner, the processing enters the key exchange phase and a key that is distinct from the keys of the above-mentioned key pair is shared between VPN client 1 and access gateway 3.

In this third embodiment of the invention, if a client certificate that is outside the scope of validation by an authentication server appears and requires validation, an access gateway for performing mutual authentication with the newly appeared client is added, together with an authentication server, a certificate validation server, the certificate validation data and the certificate data required to authenticate this client. Note, however, that because new PKI specifications can be supported by existing access gateways, it is not essential to add a new access gateway.

If an access gateway is added, it does not have to incorporate client certificate data and essentially a general-purpose access gateway is sufficient. Note, however, that because the access gateway requests public key based validation by the authentication server, the certificate validation server, the certificate validation data and the certificate data that are added at the same time as the access gateway, it is necessary to have installed software for extracting and separating the information needed for this request, specifically the user ID, the client name, the data for signing and a digital signature.

A description will now be given by way of a specific example. VPN client 1 sends, to access gateway 3, the encrypted user ID generated by using the public key of access gateway 3 to encrypt “taro@abc.com”, which is the user ID of VPN client 1. VPN client 1 also sends an encrypted random number generated by encrypting random number N1 using the public key of access gateway 3.

Access gateway 3 uses its decoding means 302 to decode the encrypted information sent from VPN client 1, thereby obtaining the user ID “taro@abc.com” of VPN client 1 and random number N1.

Next, access gateway 3 sends the user ID “taro@abc.com” of VPN client 1 to authentication server proxy 7.

Authentication server proxy 7 extracts the ID pattern “abc” from the user ID “taro@abc.com” and on the basis of this data looks up authentication server list 17 and selects authentication server 10.

Authentication server proxy 7 then sends the user ID “taro@abc.com” to authentication server 10. Authentication server 10 uses certificate retrieval means 1003 to extract, from certificate data 20, the client certificate corresponding to the user ID.

Authentication server 10 then uses certificate validation request means 1002 to send a client certificate validation request to certificate validation server 15.

Certificate validation server 15 uses certificate validation data such as the client CA certificate and the client CA certificate revocation list to validate the certificate, and sends back the result of this certificate validation to authentication server 10, whereupon authentication server 10 sends back the client certificate (which contains the public key of “taro@abc.com”) to access gateway 3 via authentication server proxy 7.

Processing continues with access gateway 3 using the public key of “taro@abc.com” to send, to VPN client 1, the encrypted access gateway user ID, which has been generated by using encryption means 305 to encrypt the user ID “server3.def.com” which client CA 6 issues to access gateway 3, together with the encrypted random number generated by encrypting a random number N2.

VPN client 1 uses its decoding means to decode the encrypted information that has been sent from access gateway 3, thereby obtaining the access gateway user ID “server3.def.com” and random number N2.

If mutual authentication is achieved in this manner, the processing enters the key exchange phase and keys are shared between VPN client 1 and access gateway 3.

In this example, if a client certificate that is outside the scope of validation by an authentication server appears and requires validation, an access gateway for performing mutual authentication with the newly added client is added, together with an authentication server, a certificate validation server, the certificate validation data and the certificate data required to authenticate this client. Note, however, that because new PKI specifications can be supported by existing access gateways, it is not essential to add a new access gateway.

If an access gateway is added, it does not have to incorporate client certificate data and essentially a general-purpose access gateway is sufficient. Note, however, that because the access gateway requests public key based validation by the authentication server, the certificate validation server, the certificate validation data and the certificate data that are added at the same time as the access gateway, it is necessary to have installed software for extracting and separating the information needed for this request, specifically the user ID, the client name, the data for signing and a digital signature.

In FIG. 6 and FIG. 7, the VPN client, access gateways, authentication server proxy, authentication servers and certificate validation servers were described as if they were hardware, but the invention is not restricted to this, and by constituting these parts as software, the invention may be configured as a centralized processing program for certificate validation which runs the sequence shown in FIG. 8.

Yet another mode of embodying the present invention will now be described in detail with reference to accompanying drawings.

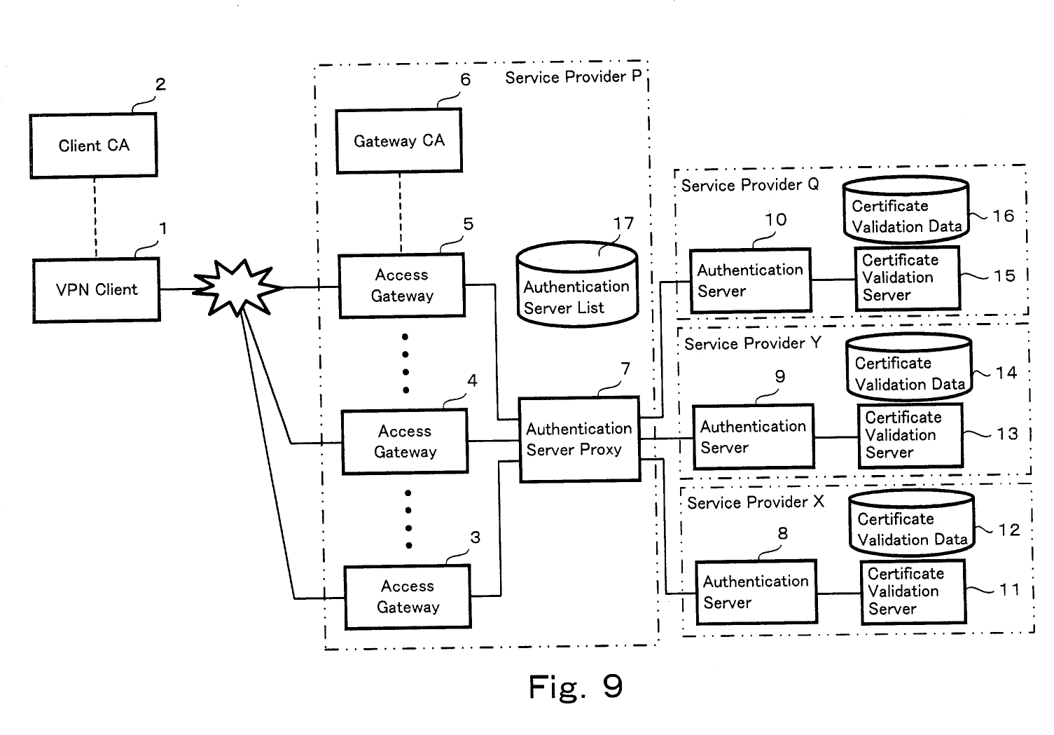

Referring to FIG. 9, this fourth embodiment of the invention shows the configuration of FIG. 1 in application to service providers. As shown in FIG. 9, gateway CA 6, access gateways 3, 4 and 5, and authentication server proxy 7 having authentication server list 17, all of which appear in FIG. 1, are allocated to service provider P. Authentication server 10 and certificate validation server 15 having certificate validation data 16, similarly appearing in FIG. 1, are allocated to service provider Q. Likewise, authentication server 9 and certificate validation server 13 having certificate validation data 14 are allocated to service provider Y. Finally, authentication server 8 and certificate validation server 11 having certificate validation data 12 are allocated to service provider X.

By thus allocating functions that are independent of PKI specification and functions that support individual PKI specifications to separate service providers, service provider P, which provides PKI specification independent functions, is able to provide access service to service providers Q, X and Y which support different PKI specifications. In addition, the fact that a single or a limited number of service providers P manage the access gateways means that the certificate specifications required at these access gateways can all be determined by the single or limited number of service providers P.

Provided that a user who is going to become a client of a VPN has a client program for validating an access gateway CA certificate, that user will be able to access the services of a variety of service providers such as X, Y and Q. Moreover, if it becomes necessary for a user who has hitherto utilized one or more of service providers X, Y and Q to access a different service provider in order to become a client of a new VPN with a different PKI specification, the client program itself does not have to be modified.

In this fourth embodiment, if a client certificate that is outside the scope of validation by an authentication server appears and requires validation, an access gateway for performing mutual authentication with the newly appeared client is added to service provider P; and a service provider equivalent to service providers Q, X and Y is also added, this new service provider having the authentication server and certificate validation server required to authenticate the new client. Note, however, that because new PKI specifications can be supported by existing access gateways, it is not essential to add a new access gateway to service provider P.

If an access gateway is added, it does not have to incorporate client certificate data, and essentially a general-purpose access gateway is sufficient. Note, however, that because the access gateway requests public key based validation by the authentication server and the certificate validation server that are added at the same time as the access gateway, it is necessary to have installed software for extracting and separating the information needed for this request, specifically the user ID, the client name, the data for signing and a digital signature.

In FIG. 9, the VPN client, access gateways, authentication server proxy, authentication servers and certificate validation servers were described as if they were hardware, but the invention is not restricted to this, and by constituting these parts as software, the invention may be configured as a certificate validation program for running the processing sequence shown in FIG. 1.

As has been described above, by dividing processing into that which uses the private key of public key cryptography, and that which uses the public key alone, and by centralizing the certificate validation procedure in the processing that uses the public key, the present invention enables extension to new types of certificate that have to be supported, without the necessity of adding to or modifying the processing that uses the private key. Moreover, because the certificate validation procedure uses a centralized public key, the addition of a new type of certificate can be dealt with simply by adding the customized software required for extracting and separating the user ID, the client name, the data for signing and a digital signature, which are needed for requesting certificate validation.

What is claimed is:

1. A certificate validation method which uses a PKI-enabled end entity to validate a certificate, said method comprising:
extracting and separating at least user ID data, client certificate data, data for signing and a digital signature; and
validating the client certificate on the basis of said extracted data.

2. The certificate validation method of claim 1, said certificate validation comprising:
analyzing the content of the certificate on the basis of said extracted data, validating the certificate on the basis of this analyzed data, and responding to a validation request in accordance with the result of this validation.

3. The certificate validation method of claim 1 or claim 2, wherein parallel certificate validation processing is performed.

4. A certificate validation apparatus which uses a PKI-enabled end entity to perform certificate validation, said certificate validation apparatus characterized in that:
the function part of said PKI-enabled end entity is divided into a first function part and a second function part;
said first function part extracts and separates at least user ID data, client certificate data, data for signing and a digital signature, and outputs this extracted data to said second function part; and
said second function part validates the client certificate on the basis of said extracted data that is input from said first function part.

5. The certificate validation apparatus of claim 4, wherein said second function part implements said certificate validation by:
analyzing the content of a certificate on the basis of said extracted data;
validating the certificate on the basis of this analyzed data; and
responding to a validation request in accordance with the result of said validation.

6. The PKI-enabled certificate validation apparatus of claim 4, wherein said second function part performs parallel processing of certificate validation.

7. The certificate validation apparatus of claim 4, wherein:
said second function part has an authentication server proxy and an authentication part;
said authentication server proxy identifies the type of certificate contained in said extracted data, allocates certificate validation processing corresponding to the certificate type, and responds to a request for a validation result; and
said authentication part validates certificates on the basis of said extracted data distributed by said authentication server proxy in accordance with certificate type, and outputs the validation result to the authentication server proxy.

8. The certificate validation apparatus of claim 7, wherein:
said authentication part has authentication servers and certificate validation servers;
said authentication servers analyze certificate content, output requests for certificate validation to said certificate validation servers, and respond to requests from said authentication server proxy for validation results; and
said certificate validation servers validate certificates on the basis of the analyzed data from said authentication servers, in response to certificate validation requests from said authentication servers, and output the results of this validation to said authentication servers.

9. The certificate validation apparatus of claim 8, wherein:
said authentication servers are additionally provided with the functions of said certificate validation servers.

10. A certificate validation program incorporated in a PKI-enabled end entity and adapted to validate certificates, wherein:
the function part of a PKI-enabled end entity is divided according to function into a first function part and a second function part and constructed as software;
said first function part is software which implements the function of extracting and separating at least user ID data, client certificate data, data for signing and digital signature, and of outputting this extracted data to said second function part;
said second function part is software which implements the function of validating client certificates on the basis of said extracted data that is input from said first function part; and
these two pieces of software cause a computer to function.

11. The certificate validation program of claim 10, wherein the software constituting said second function part implements said certificate validation function by analyzing the content of the certificate on the basis of said extracted data, validating the certificate on the basis of this analyzed data, and responding to a validation request in accordance with the result of this validation.

12. The certificate validation program of claim 10 or 11, wherein the software constituting said second function part performs parallel processing of certificate validation.
